(19) United States
(12) Patent Application Publication
(10) Pub. No.: US 2007/0178312 A1
(43) Pub. Date: Aug. 2, 2007

(54) TRANSFER MEDIUM CARRYING MEMBER, INTERMEDIATE TRANSFER MEMBER AND IMAGE FORMING APPARATUS USING THE SAME

(75) Inventors: Daisuke Miura, Numazu-shi (JP); Shunichiro Nishida, Tokyo (JP); Yasuhiro Naito, Kawasaki-shi (JP); Tomonari Nakayama, Yokohama-shi (JP); Naotoshi Miyamachi, Tokyo (JP); Teigo Sakakibara, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/697,952

(22) Filed: Apr. 9, 2007

Related U.S. Application Data
(62) Division of application No. 11/144,743, filed on Jun. 6, 2005.

(30) Foreign Application Priority Data
Jun. 8, 2004 (JP) 2004-170143
Mar. 1, 2005 (JP) 2005-055808

(51) Int. Cl. G03G 15/20; B32B 27/36; B32B 27/20

(52) U.S. Cl. 428/412; 428/447; 399/308

(57) ABSTRACT

The present invention relates to a transfer medium carrying member that excels in flame retardancy and provides good electrophotographical images. The transfer medium carrying member includes i) a resin and ii) a conductive filler, wherein the resin comprises a polycarbonate resin (a) that has a structural unit including a siloxane structure and a structural unit including a fluorene structure.

### BACKGROUND OF THE INVENTION

1. Field of the Invention

The present invention relates to a transfer medium carrying member or intermediate transfer member and an image forming apparatus, particularly to a transfer medium carrying member used in transferring the toner image formed on an image bearing member by electrophotographic or electrostatic recording process to a transfer medium or an intermediate transfer member which transfers the toner image on an image bearing member, and an image forming apparatus which includes the above transfer medium carrying member or intermediate transfer member. Such image forming apparatus include: monochrome or full color electrophotographic copiers, printers and other types of recording machines.

2. Related Background Art

There have been various transfer medium carrying members used in transferring the image on an image bearing member to a transfer medium. For example, in an electrophotographic apparatus that includes image forming means, such as charging means—image exposing means—toner developing means—transferring means—cleaning means, means of transferring the toner image on a photosensitive member to a transfer medium (e.g. paper) include: for example, a transfer drum and a transfer device shown in FIGS. 1 and 2, respectively.

In FIG. 1, a transfer drum 10 includes a substrate made up of: cylinders 12, 13 arranged at both ends of the transfer drum and a connecting portion 14 that connects the above two cylinders, and over the opening area of the outer peripheral surface of the substrate is stretched a transfer medium carrying member 11. The above described connecting portion 14 includes a transfer medium gripper 15 which grips the transfer medium fed from a paper feeding device.

The transfer drum 10 made up as above is disposed in a transfer device shown in FIG. 2. It has a transferring discharger 21 as well as an inside electricity removing discharger 23 and outside electricity removing dischargers 22, 24, which constitute electricity removing means, disposed on its inside and outside. In the same figure, reference numeral 25 denotes a discharge wire, numeral 26 an insulating member, numeral 27 a pressure member, numeral 28 a separation claw and numeral 31 a rotary developing device.

There is also known an electrophotographic apparatus of a type in which the toner image formed on a photosensitive member is first transferred to an intermediate transfer member and then the toner image on the intermediate transfer member is transferred to a transfer medium.

In the image transferring process in the above described image forming apparatus, various mechanical or electric external forces are imposed on the transfer medium carrying member 11 when it is carried, or transfer charging, electricity removing and cleaning of the transfer medium carrying member are conducted. Therefore the transfer medium carrying member 11 is required to have endurance against these external forces; in other words, the transfer medium carrying member 11 is required to have various properties such as mechanical strength, wear resistance and electrical durability. And the intermediate transfer member is also required to have the same properties.

In recent years, in order to provide color/full-color image innovation as well as higher-speed electrophotographic processes, electrophotographic systems have been more and more used in which toner images of three colors—cyan, magenta and yellow or of four colors—cyan, magenta, yellow and black are successively and continuously transferred to the transfer medium on a transfer medium carrying member or to an intermediate transfer member. Particularly in full-color electrophotographic apparatus, since transferring process is continuously performed, the transfer medium carrying member or the intermediate transfer member is required to have much better charge-up properties and withstand voltage properties.

For the transfer medium carrying member and the intermediate transfer member, resins such as polytetrafluoroethylene, polyester, polyvinylidene fluoride, triacetate and polycarbonate, or elastomers such as isoprene, butadiene, styrene-butadiene, chloroprene-acrylo rubber, urethane, silicone and acryl have been used. However, in these resins or elastomers, the resistance value is too high when they are used alone, which causes a phenomenon of charge-up and sometimes results in void or defect of transferred colorant.

As one of the measures to prevent such charge-up, there have been proposed methods for producing an intermediate transfer belt having a specified resistance value by using a resin in which carbon black particles etc. are dispersed as a conductive filler (Hereinafter, referred to as conductive filler) (Japanese Patent Publication No. S60-10625, Japanese Patent Application Laid-Open No. H4-303871). However, the flame retardancy of the resultant transfer medium carrying member or intermediate transfer member can sometimes be lowered depending on the amount of the conductive filler dispersed. Further, it is sometimes difficult to disperse conductive filler particles uniformly in a resin, depending on the type of the resin used as a dispersion medium. In such a case, the resistance of the resultant transfer medium carrying member or intermediate transfer member becomes non-uniform, which can sometimes cause interference with smooth transfer of toner images or lower the mechanical strength of the transfer medium carrying member or intermediate transfer member.

### SUMMARY OF THE INVENTION

Accordingly, an object of the present invention is to provide a transfer medium carrying member and an intermediate transfer member which exhibit excellent flame retardancy even when a conductive filler is added thereto and have good image properties as well as excellent mechanical properties.

Another object of the present invention is to provide an image forming apparatus that stably provides high-quality images.

According to the present invention, provided is a transfer medium carrying member used in an electrophotographic apparatus, including i) a resin and ii) a conductive filler, wherein the resin includes a polycarbonate resin (a) having a structural unit including a siloxane structure and a structural unit including a fluorene structure.

According to the present invention, also provided is an electrophotographic apparatus, including the above described transfer medium carrying member, which supports at least one of a transfer medium to which a toner image formed on an image bearing member is to be transferred and a transfer medium to which a toner image formed on the image bearing member has been transferred.

According to the present invention, also provided is an intermediate transfer member used in an electrophotographic apparatus, including i) a resin and ii) a conductive filler, wherein the resin includes a polycarbonate resin (a) having a structural unit including a siloxane structure and a structural unit including a fluorene structure.

The present invention also provides an electrophotographic apparatus, including the above described intermediate transfer member, to which a toner image formed on an image bearing member is transferred and which then transfers the transferred toner image toga transfer medium.

According to the present invention, a transfer medium carrying member or an intermediate transfer member can be obtained which is capable of inhibiting charge-up with a conductive filler added thereto, is capable of providing excellent images free from faults, such as non-uniformity or defect of transferred colorant, excels in flame retardancy and has high strength.

According to the present invention, an image forming apparatus can also be obtained which provides high-quality electrophotographic images stably.

### BRIEF DESCRIPTION OF THE DRAWINGS

FIG. 1 is a schematic block diagram of a transfer drum which uses a transfer medium carrying member of the present invention;

FIG. 2 is a schematic block diagram of a transfer device which uses a transfer medium carrying member of the present invention;

FIG. 3 is a schematic block diagram of an image forming apparatus which uses a transfer medium carrying member in the form of a sheet of the present invention;

FIG. 4 is a schematic block diagram of an image forming apparatus which uses a transfer medium carrying member in the form of a sheet of the present invention;

FIG. 5 is a schematic block diagram of an image forming apparatus which uses a transfer medium carrying member in the form of an endless belt of the present invention;

FIG. 6 is a schematic block diagram of another image forming apparatus which uses a transfer medium carrying member in the form of an endless belt of the present invention;

FIG. 7 is a schematic block diagram of an image forming apparatus which uses an intermediate transfer member in the form of an endless belt of the present invention; and

FIG. 8 is a schematic block diagram of another image forming apparatus which uses an intermediate transfer member in the form of an endless belt of the present invention.

### DESCRIPTION OF THE PREFERRED EMBODIMENTS

The transfer medium carrying member in accordance with one embodiment of the present invention includes:
i) a resin; and
ii) a conductive filler,
   wherein the resin comprises a polycarbonate resin (Hereinafter, sometimes referred to as “ingredient a”) having a structural unit including a siloxane structure and a structural unit including a fluorene structure.

The intermediate transfer member in accordance with the present invention includes:
i) a resin; and
ii) a conductive filler,
   wherein the resin comprises a polycarbonate resin (Hereinafter, sometimes referred to as “ingredient a”) having a structural unit including a siloxane structure and a structural unit including a fluorene structure.

Specific examples of structural units including a siloxane structure and structural units including a fluorene structure include: those represented by the following general formula (1) and those represented by the following general formula (3), respectively.

The transfer medium carrying member and intermediate transfer member in accordance with the present invention may contain not only the polycarbonate resin, as an ingredient a, but also a polycarbonate resin different from the above ingredient a (Hereinafter, sometimes referred to as ingredient b). Specific examples of polycarbonate resins, as an ingredient b, include those having a structural unit represented by the following general formula (1) and a structural unit represented by the following general formula (2). 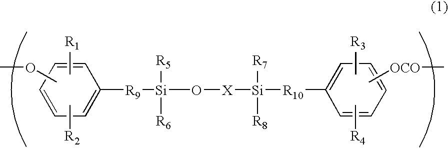
wherein R₁ to R₄ each independently represent a hydrogen, an alkyl group having 1 to 5 carbon atoms, an aryl group having 6 to 12 carbon atoms, an alkenyl group having 2 to 5 carbon atoms, an alkoxy group having 1 to 5 carbon atoms or an aralkyl group having 7 to 17 carbon atoms; R₅ to R₈ each independently represent a hydrogen, an alkyl group having 1 to 5 carbon atoms, an aryl group having 6 to 12 carbon atoms, an alkenyl group having 2 to 5 carbon atoms, an alkoxy group having 1 to 5 carbon atoms or an aralkyl group having 7 to 17 carbon atoms; R₉ and R₁₀ each independently represent a single bond or a divalent aliphatic hydrocarbon group having 1 to 6 carbon atoms; and
X is a single bond, a linking group composed of any one structural unit selected from the group consisting of structural units represented by [—SiO(R₁₁)(R₁₂)—], [—SiO(R₁₃)(R₁₄)—] or [—SiO(R₂₉)(R₃₀)—], or a linking group composed of a polymer of at least one structural unit selected from the group consisting of the above three structural units, wherein
when the above linking group is composed of a polymer of at least one structural unit selected from the group consisting of the above three structural units, the sum of the polymerization degree is 2 to 200, when the above linking group is composed of a polymer of at least two structural units selected from the group consisting of the above three structural units, the polymer is a block or random copolymer of the structural units, and
in the above structural units, R₁₁ to R₁₄ and R₂₉ to R₃₀ each independently represent a hydrogen, an alkyl group having 1 to 5 carbon atoms, an aryl group having 6 to 12 carbon atoms, an alkenyl group having 2 to 5 carbon atoms, an alkoxy group having 1 to 5 carbon atoms or an aralkyl group having 7 to 17 carbon atoms, the combinations of R₁₁ and R₁₂, R₁₃ and R₁₄, and R₂₉ and R₃₀ are different from one another, 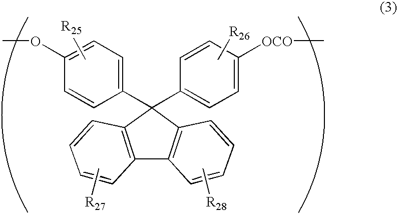
   wherein R₂₅ to R₂₈ each independently represents a hydrogen, an alkyl group having 1 to 5 carbon atoms, an aryl group having 6 to 12 carbon atoms, an alkenyl group having 2 to 5 carbon atoms, an alkoxy group having 1 to 5 carbon atoms or an aralkyl group having 7 to 17 carbon atoms. 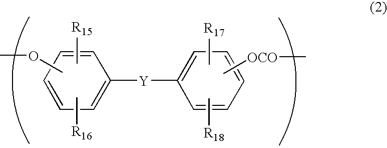
   wherein R₁₅ to R₁₈ each independently represent a hydrogen, an alkyl group having 1 to 10 carbon atoms, an aryl group having 6 to 12 carbon atoms, an alkenyl group having 2 to 5 carbon atoms, an alkoxy group having 1 to 5 carbon atoms or an aralkyl group having 7 to 17 carbon atoms; and
Y represents 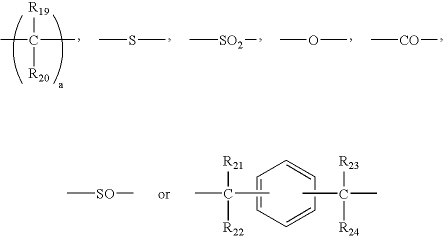
   wherein R₁₉ to R₂₀ each independently represent a hydrogen, an alkyl group having 1 to 10 carbon atoms, an alkenyl group having 2 to 5 carbon atoms, an alkoxy group having 1 to 5 carbon atoms or an aryl group having 6 to 12 carbon atoms, and R₂₁ to R₂₄ each independently represent a hydrogen, an alkyl group having 1 to 10 carbon atoms, an alkenyl group having 2 to 5 carbon atoms, an alkoxy group having 1 to 5 carbon atoms or aryl group having 6 to 12 carbon atoms, or an atomic group forming a carbon ring having 3 to 12 carbon atoms or heterocyclic ring (excluding a fluorene structure) together with R₂₁ and R₂₂, or R₂₃ and R₂₄; and a is an integer of 0 to 20.

In the following the polycarbonate resins, as ingredients a and b, will be described.

In the polysiloxane structure-including structural unit in the polycarbonate resins as ingredients a and b, which is represented by the above general formula (I), it is preferable that R₅ to R₈ are each independently a methyl or phenyl group. More specifically, it is preferable that the structural unit represented by the above general formula (1) is at least one of the structures represented by the following formulae (4) and (5). 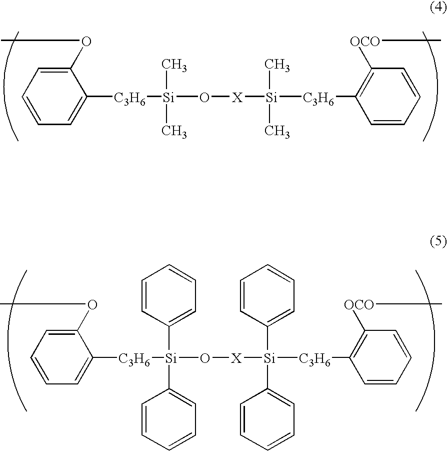
wherein X is a single bond, a linking group composed of any one structural unit selected from the group consisting of structural units represented by [—SiO(R₁₁)(R₁₂)—], [—SiO(R₁₃)(R₁₄)—] or [—SiO(R₂₉)(R₃₀)—] or a linking group composed of a polymer of at least one structural unit selected from the group consisting of the above three structural units, wherein
when the above linking group is composed of a polymer of at least one structural unit selected from the group consisting of the above three structural units, the sum of the polymerization degree is 2 to 200, when the above linking group is composed of a polymer of at least two structural units selected from the group consisting of the above three structural units, the polymer is a block or random copolymer of the structural units, and
in the above structural units, R₁₁ to R₁₄, R₂₉ to R₃₀ each independently represent a hydrogen, an alkyl group having 1 to 5 carbon atoms, an aryl group having 6 to 12 carbon atoms, an alkenyl group having 2 to 5 carbon atoms, an alkoxy group having 1 to 5 carbon atoms or an aralkyl group having 7 to 17 carbon atoms, the combinations of R₁₁ and R₁₂, R₁₃ and R₁₄, and R₂₉ and R₃₀ are different from one another.

Specific examples of compounds from which the structural units represented by the above formula (1) are derived include those represented by the following structural formulae (1)-1 to (1)-12.

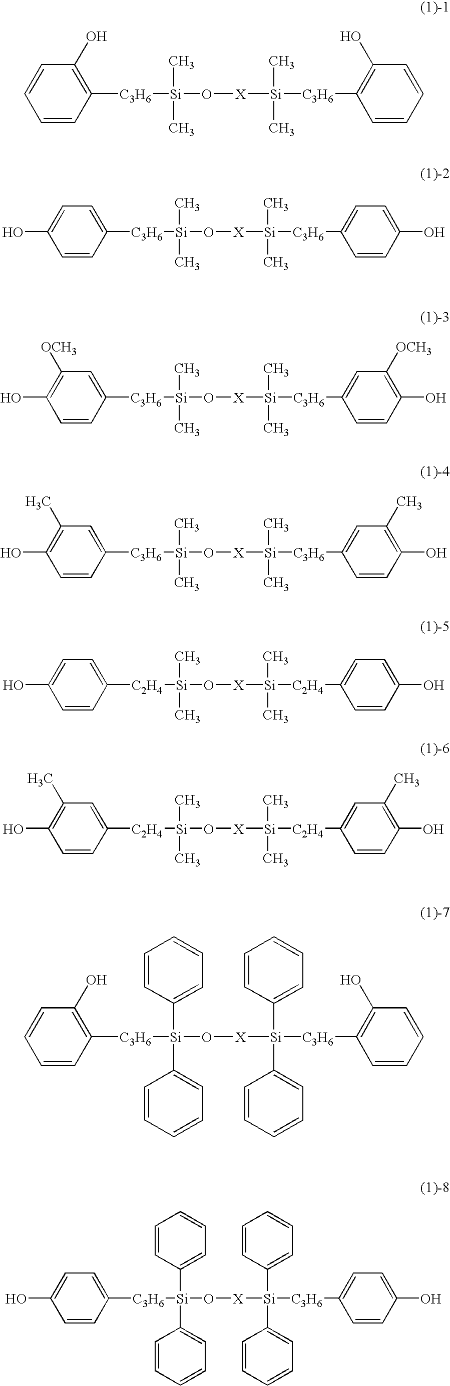

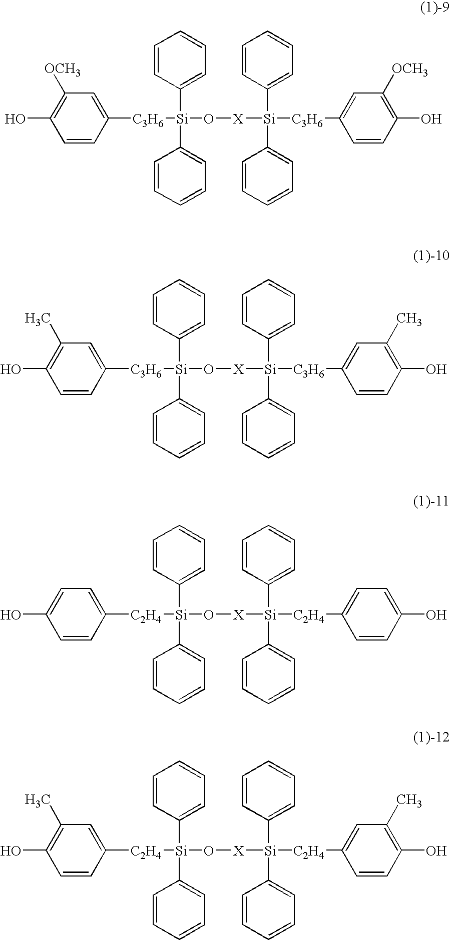

In the above formulae (1)-1 to (1)-12, X is a linking group composed of at least one structural unit selected from the group consisting of 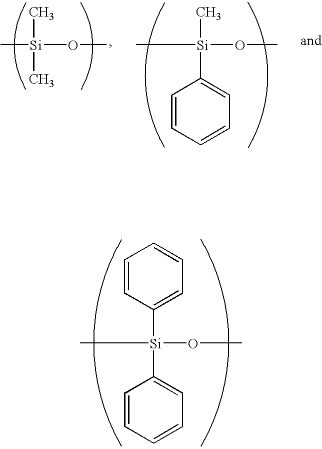
or composed of the polymer of the structural unit. When the above linking group is composed of a polymer of at least two structural units selected from the group consisting of the above three structural units, the polymer is a block or random copolymer of the structural units. When the above linking group is composed of a polymer of any one structural unit selected from the group consisting of the above three structural units, the sum of the polymerization degree is 2 to 200. Preferably, X is a linking group composed of a polymer containing 1 to 100 dimethyl siloxane structures or 1 to 100 diphenyl siloxane structures or composed of a random copolymer containing the above two types of structures.

It is possible to use simultaneously two or more of the compounds exemplified above from which the structural units represented by the above formula (1) are derived. As compounds from which the structural units represented by the above formula (1) are derived, preferable are α,ω-bis[3-(o-hydroxyphenyl)propyl]polydimethyldiphenyl random copolymer siloxane, which is included in the structure represented by the above formula (1)-1 or (1)-7, and α,ω-bis[3-(o-hydroxyphenyl)propyl]polydimethyl siloxane, which is included in the structure represented by the above formula (1)-7.

Specific examples of compounds from which structural units, which are represented by the above general formula (2), in the polycarbonate resin, as an ingredient b, are derived include: 4,4′-biphenyldiol, bis(4-hydroxyphenyl)methane, bis(4-hydroxyphenyl)ether, bis(4-hydroxyphenyl)sulfone, bis(4-hydroxy-3-methylphenyl)sulfone, bis(4-hydroxyphenyl)sulfoxide, bis(4-hydroxyphenyl)sulfide, bis(4-hydroxyphenyl)ketone, 1,1-bis(4-hydroxyphenyl)ethane, 2,2-bis(4-hydroxyphenyl)propane (bisphenol A; BPA), 2,2-bis(4-hydroxyphenyl)butane, 1,1-bis(4-hydroxyphenyl)cyclohexane (bisphenol Z; BPZ), 2,2-bis(4-hydroxy-3-methylphenyl)propane (dimethyl bisphenol A), 2,2-bis(4-hydroxy-3,5-dimethylphenyl)propane, 1,1-bis(4-hydroxyphenyl)-1-phenylethane (bisphenol AP; BPAP), bis(4-hydroxyphenyl)diphenylmethane, 2,2-bis(4-hydroxy-3-allylphenyl)propane, and 3,3,5-trimethyl-1,1-bis(4-hydroxyphenyl)cyclohexane (trimethyl bisphenol-Z; TMBPZ). It is possible to use simultaneously two or more of these compounds. Of these compounds, 2,2-bis(4-hydroxyphenyl)propane is particularly preferable.

Specific examples of compounds from which the structural unit represented by the above general formula (3), in the polycarbonate resin as an ingredient a are derived, include: 9,9-bis(4-hydroxy-2-methylphenyl)fluorene, 9,9-bis(4-hydroxy-3-methylphenyl)fluorene, 9,9-bis(4-hydroxyphenyl)fluorene, 3,6-dimethyl-9,9-bis(4-hydroxyphenyl)fluorene, 9,9-bis(3-methoxy-4-hydroxyphenyl)fluorene, 9,9-bis(3-ethoxy-4-hydroxyphenyl)fluorene, 9,9-bis(3-ethyl-4-hydroxyphenyl)fluorene, 4,5-dimethyl-9,9-bis(4-hydroxyphenyl)fluorene, 9,9-bis(3-phenyl-4-hydroxyphenyl)fluorene, 3,6-dimethyl-9,9-bis(3-methyl-4-hydroxyphenyl)fluorene, and 3,6-diphenyl-9,9-bis(4-hydroxyphenyl)fluorene. Of these compounds, 9,9-bis(4-hydroxyphenyl)fluorene, 9,9-bis(4-hydroxy-3-methylphenyl)fluorene and 9,9-bis(4-hydroxy-2-methylphenyl)fluorene are particularly preferable. It is possible to use simultaneously two or more of these compounds. Containing structural units represented by the above formulae (1) and (3) is indispensable to the polycarbonate resin, as an ingredient a; however, the polycarbonate resin, as an ingredient a, may further contain other structural units, for example, structural units represented by the above formula (2), which are structural units of the polycarbonate resin, as an ingredient b.

The polycarbonate resin, as an ingredient a, is synthesized by reacting, with a carbonate ester-forming compound, each of the compound from which a structural unit represented by the above general formula (1) is derived, the compound from which a structural unit represented by the above general formula (3) is derived, and the compound from which a structural unit other than those represented by the above formulae (1) and (3), for example, a structural unit represented by the above formula (2) is derived in amounts of 10 to 90% by weight, 10 to 90% by weight and 0 to 80% by weight per 100% of the above three compounds, respectively.

The polycarbonate resin, as an ingredient b, is synthesized by reacting, with a carbonate ester-forming compound, each of the compound from which a structural unit represented by the above general formula (1) is derived and the compound from which a structural unit represented by the above general formula (2) is derived in amounts of 0.1 to 50% by weight and 50 to 99.9% by weight per 100% of the above two compounds, respectively.

As a process for reacting the compounds from which the respective structural units are derived with a carbonate ester-forming compound, can be used a known process which is used, for example, when producing a polycarbonate derived from bisphenol A, such as direct reaction of bisphenols with phosgene (phosgene process) or ester exchange reaction of bisphenols with bisaryl carbonate (ester exchange process).

Examples of the above described carbonate ester-forming compounds include: phosgene; and bisaryl carbonates such as diphenyl carbonate, di-p-tolyl carbonate, phenyl-p-tolyl carbonate, di-p-chlorophenyl carbonate and dinaphtyl carbonate. It is possible to use simultaneously two or more of these compounds.

In the former process—that is, phosgene process, the compound from which the structural unit represented by the general formula (1) is derived, the compound from which the structural unit represented by the general formula (2) is derived and the compound from which the structural unit represented by the general formula (3) is derived in the present invention are reacted with phosgene usually in the presence of an acid-binding agent and a solvent. Examples of acid-binding agents applicable to the reaction include: pyridine; and hydroxides of alkali metals such as sodium hydroxide and potassium hydroxide. Examples of solvents applicable to the reaction include: methylene chloride, chloroform, chlorobenzene and xylene. To accelerate the condensation polymerization reaction, a catalyst—a tertiary amine catalyst such as triethylamine is added. To adjust the polymerization degree, a mono-functional compound such as phenol, p-t-butylphenol, p-cumylphenol, alkyl-substituted phenols, alkyl hydroxybenzoates or alkyloxyphenols is added as a molecular weight modifier. If desired, an antioxidant such as sodium sulfite or hydrosulfite or a chain-branching agent such as phloroglucine, isatin-bisphenol, 1,1,1-tris(4-hydroxyphenyl)ethane or α,α′,α″-tris(4-hydroxyphenyl)-1,3,5-triisopropylbenzen may be added in small amounts. The reaction temperature is usually in the range of 0 to 150° C. and preferably in the range of 5 to 40° C. The reaction time varies depending on the reaction temperature; however, it is usually 0.5 min to 10 hrs and preferably 1 min to 2 hrs. Preferably, the pH of the reaction system is kept at 10 or more during the reaction.

Meanwhile, in the latter process—that is, ester exchange process, the compound from which the structural unit represented by the general formula (1) is derived, the compound from which the structural unit represented by the general formula (2) is derived and the compound from which the structural unit represented by the general formula (3) is derived in the present invention are mixed with bisaryl carbonate and allowed to react at high temperatures under reduced pressure. In this reaction, a mono-functional compound such as phenol, p-t-butylphenol, p-cumylphenol, alkyl-substituted phenols, alkyl hydroxybenzoates or alkyloxyphenols may be added as a molecular weight modifier. The reaction is usually carried out at 150 to 350° C. and preferably at 200 to 300° C., and the ultimate pressure reduction degree is preferably 1 mmHg or less so that phenols associated with the above bisaryl carbonate which are produced by the ester exchange reaction is distilled off out of the system. The reaction time is usually about 1 to 6 hours, though it varies depending on the reaction temperature or the pressure reduction degree. Preferably, the reaction is carried out under an inert gas atmosphere such as nitrogen or argon. If desired, an antioxidant or a chain-branching agent may be added for the reaction.

Comparing the phosgene process and the ester exchange process, the phosgene process is preferable in terms of the reactivity of the compound from which the structural unit represented by the general formula (1) is derived, the compound from which the structural unit represented by the general formula (2) is derived and the compound from which the structural unit represented by the general formula (3) is derived.

Tertiary amine polymerization catalysts applicable include: for example, triethylamine, tri-n-propylamine, tri-n-butylamine, N,N′-dimethylcyclohexylamine, N,N′-diethylaniline and diethylaminopyridine; however, when the phosgene process is employed in the present invention, triethylamine is preferably used from the viewpoint of catalytic activity or removability by cleaning. The amount of the polymerization catalyst added is preferably 0.001 to 5 mol % per 100 mol % of bisphenols used.

When the phosgene process is employed in the present invention, a small amount of quaternary ammonium salt may be added to carry out the reaction efficiently. Specific examples of quaternary ammonium salts include: tetramethylammonium chloride, trimethylbenzylammonium chloride, triethylbenzylammonium chloride, tetraethylammonium bromide and tetra-n-butylammonium iodide. Of these quaternary ammonium salts, trimethylbenzylammonium chloride and triethylbenzylammonium chloride are preferable. Typically, the amount of the quaternary ammonium salt added is preferably 0.0005 to 5 mol % per 100 mol % of bisphenols used.

When using a molecular weight modifier in the present invention, monovalent phenol is particularly preferably used. Specific examples of monovalent phenol include: phenol; alkyl-substituted phenols such as butyl phenol, octyl phenol, nonyl phenol, decanyl phenol, tetradecanyl phenol, heptadecanyl phenol and octadecanyl phenol; alkyl hydroxybenzoate esters such as butyl hydroxybenzoate, octyl hydroxybenzoate, nonyl hydroxybenzoate, decanyl hydroxybenzoate and heptadecanyl hydroxybenzoate; and alkyloxy phenols such as butoxy phenol, oxtyloxy phenol, nonyloxy phenol, decanyloxy phenol, tetradecanyloxy phenol, heptadecanyloxy phenol and octadecanyloxy phenol. The amount of the molecular weight modifier added is 0.1 to 50 mol % per 100 mol % of bisphenols and preferably 0.5 to 10 mol %.

Preferably, the thermoplastic polycarbonate resin (ingredient a) and thermoplastic polycarbonate resin (ingredient b) of the present invention, which are derived from compounds having a siloxane structure and a fluorene structure, synthesized by the above described reactions have an intrinsic viscosity in the range of 0.2 to 1.0 dl/g. Polycarbonate resins having an intrinsic viscosity within the above described range excel in mechanical strength and moldability.

In the thermoplastic polycarbonate resin (ingredient b) used in the present invention, the content of the compound from which the structural unit represented by the general formula (1) is derived is preferably 0 to 50% by weight and more preferably 0 to 30% by weight per 100% by weight of all the monomers used. In the thermoplastic polycarbonate resin (ingredient a) used in the present invention, the content of the compound from which the structural unit represented by the general formula (1) is derived is preferably 1 to 80% by weight and more preferably 2 to 50% by weight per 100% by weight of all the monomers used.

Further, the amount of the compound from which the structural unit represented by the general formula (1) is derived is preferably 1 to 50% by weight and more preferably 2 to 20% by weight per 100% by weight of all the monomers used in the thermoplastic polycarbonate resins, (ingredient a) and (ingredient b), of the present invention.

If, in the polycarbonate resins, ingredient a and ingredient b, the ratio of the compound from which the structural unit represented by the general formula (1) is derived to the total monomers used is in the above described range, the transfer medium carrying member or intermediate transfer member of the present invention, which includes such polycarbonate resins, is surely provided with intended flame retardancy and sufficient strength required for a molded product.

For the thermoplastic polycarbonate resin composition of the present invention, thermogravimetric analysis under nitrogen preferably indicates thermal weight loss of 1% at a temperature of 380° C. or higher and/or 5% at a temperature of 430° C. or higher. More preferably, the thermal weight loss occurs by 1% at a temperature of 400° C. or higher and/or by 5% at a temperature of 450° C. or higher.

In the following, the conductive filler (ingredient c) will be described.

As the conductive filler in the thermoplastic polycarbonate resin composition of the present invention, for example, a conductive carbon can be used. Examples of preferably used a conductive carbon include: a conductive carbon black and carbon fibers, though any types of a conductive carbon can be used. Specific examples of a conductive carbon black include: super conductive furnace black, conductive furnace black, extraconductive furnace black, superabrasion furnace black and carbon fibrils.

The conductive carbon must be such carbon black that its n-dibutyl phthalate (DBP) oil absorption is preferably 100 to 500 ml/100 g and more preferably 120 to 400 ml/100 g. If the DBP oil absorption is larger than 500 ml/100 g, the dispersion of the carbon worsens, which causes a large amount of agglomerates to exist in the molded product of the resin composition. On the other hand, if the DBP oil absorption is smaller than 100 ml/100 g, the carbon produces less conductivity-imparting effect. Thus, carbon having a DBP oil absorption outside the above range is not preferable. Examples of carbon black having the above described preferable property include: those commercially available as a conductive carbon black, such as Ketjenblack EC, by Lion Corporation, VULCAN XC-72, XC-305, XC-605, by Cabot Corporation and Denka Black by Denki Kagaku Kogyo Kabusiki Kaisya. They also include: carbon black having the above described preferable property which is by-produced when producing a synthetic gas containing hydrogen and carbon monoxide by the partial oxidization of hydrocarbon, such as naphtha, in the presence of hydrogen and oxygen, or carbon black produced by subjecting the above carbon black to oxidization or reduction treatment. The above a conductive carbon black has preferably an average particle diameter of 10 to 100 μm and a specific surface area of 200 m²/g or more.

A conductive carbon also includes carbon fibers. Specific examples of such carbon fibers are: those having an average fiber diameter of 200 nm or less and a tubular structure of single layer or multi-layer. For example, the carbon fibrils described in National Publication of International Patent Application No. 8-508534 is preferably used.

A carbon fibril include a graphite external layer built-up substantially concentricly along the cylindrical shaft. The central shaft of the fiber does not take the form of a linear tube, but does take the form of a winding tube. The average fiber diameter of a carbon fibril is almost uniform, though it varies depending on the production process.

Carbon fibrils of average fiber diameter 200 nm or less are preferably used, and the carbon fibrils of average fiber diameter of 20 nm or less are particularly preferable because the resistance of the resultant molded product becomes uniform. On the other hand, the average fiber diameter of carbon fibrils are preferably 0.1 nm or more and particularly preferably 0.5 nm or more in view of the production thereof.

Preferably carbon fibrils have the length—average fiber diameter ratio (length/diameter) of 5 or more, more preferably 100 or more and particularly preferably 1000 or more. The thickness of the wall of carbon fibers which take the form of a very fine tube is usually about 3.5 to 75 nm. These values correspond to about 0.1 to 0.4 times the outside diameter of typical fibrils.

The amount of the conductive carbon (ingredient c) in the thermoplastic polycarbonate resin composition of the present invention is 0.5 to 30% by weight and preferably 0.5 to 15% by weight per 100% by weight of the sum of (ingredient a)+(ingredient b)+(ingredient c). If the amount of the conductive carbon is less than 0.5% by weight, the conductivity of the resin composition becomes insufficient, whereas if the amount is more than 30% by weight, the moldability of the resins composition significantly deteriorates or the strength of the molded product becomes lower. When the amount of the conductive carbon is smaller within the above range, the conductivity of the resin composition can sometimes be lowered at low voltages; however, even in such a case, sufficient conductivity can be obtained by applying a higher voltage.

As a process for preparing the thermoplastic polycarbonate resin composition of the present invention, any conventionally known processes can be used. For example, suitably used is a process in which thermoplastic resin powder and a conductive carbon are mixed, a melt-kneading process in which a molten thermoplastic resin and a conductive carbon are mixed and kneaded, or a process in which first, a conductive carbon is dispersed in a solution of a thermoplastic resin in a solvent and then the solvent is removed appropriately.

In the preparation of the transfer medium carrying member or intermediate transfer member of the present invention, besides aforementioned ingredients a, b and c, for example, an organic sulfonic acid metal salt can be added as an optional ingredient d.

Examples of metal organic sulfonates used include, not limited to, metal aliphatic sulfonates and metal aromatic sulfonates. As metals of metal sulfonates, alkali metals and alkali earth metals are preferably used. Alkali metals and alkali earth metals used include, for example, sodium, lithium, potassium, rubidium, cesium, beryllium, magnesium, calcium, strontium and barium. Metal sulfonates can be used each independently or in the form of a mixture of two or more kinds.

As metal organic sulfonates as ingredient d, metal perfluoroalkanesulfonates and metal aromatic sulfone sulfonates are preferable from the viewpoint of flame retardancy and thermal stability.

As metal perfluoroalkanesulfonate, preferable are alkali metal salts of perfluoroalkanesulfonic acid and alkali earth metal salts of perfluoroalkanesulfonic acid and more preferable are alkali metal sulfonates having a C₄₋₈ perfluoroalkane group and alkali earth metal sulfonates having a C₄₋₈ perfluoroalkane group.

Specific examples of metal perfluoroalkanesulfonate include: sodium perfluorobutanesulfonate, potassium perfluorobutanesulfonate, sodium perfluoromethylbutanesulfonate, potassium perfluoromethylbutanesulfonate, sodium perfluorooctanesulfonate, potassium perfluorooctanesulfonate, and tetraethylammonium perfluorobutanesulfonate.

As metal aromatic sulfone sulfonate, preferable are alkali metal aromatic sulfone sulfonates and alkali earth metal aromatic sulfone sulfonates. Alkali metal aromatic sulfone sulfonates and alkali earth metal aromatic sulfone sulfonates may be polymers.

Specific examples of metal aromatic sulfone sulfonates include sodium diphenylsulfone-3-sulfonate, potassium diphenylsulfone-3-sulfonate, sodium 4,4′-dibromodiphenyl-sulfone-3-sulfonate, potassium 4,4′-dibromodiphenyl-sulfone-3-sulfonate, calcium 4-chloro-4′-nitrodiphenylsulfone-3-sulfonate, disodium diphenylsulfone-3,3′-disulfonate and dipotassium diphenylsulfone-3,3′-disulfonate.

The organic metal compound (ingredient d) is added in an amount of 0.01 to 0.5% by weight per 100% by weight of the sum of (ingredient a)+(ingredient b)+(ingredient c). If its amount is less than 0.01% by weight, the flame retardancy imparting effect is lowered, whereas if its amount is more than 0.5% by weight, the enhancement of the flame retardancy imparting effect cannot be expected, and besides, expanding of the molded product, deterioration of folding endurance or poor appearance may be caused.

The thermoplastic polycarbonate resin composition of the present invention may contain various kinds of thermoplastic resins and additives, as long as it can produce the effect of the present invention.

Examples of thermoplastic resins other than polycarbonate resin include: polyester (polyethylene terephthalate, polybutylene terephthalate, etc.), polyamide, polyethylene, polypropylene, polystyrene, acrylonitrile-styrene (AS) resin, acrylonitrile-butadiene-styrene (ABS) resin and polymethylmethacrylate. As elastomers, for example, isobutylene-isoprene rubber, styrene-butadiene rubber, ethylene-propylene rubber, acrylic elastomer, polyester elastomer, polyamide elastomer, and thermoplastic elastomer such as MBS and MAS as core-shell type elastomer can also be used.

Various types of additives mixed include: for example, reinforcers (talc, mica, cray, wollastonite, calcium carbonate, glass fibers, glass beads, glass balloon, milled fibers, glass flakes, carbon fibers, carbon flakes, carbon beads, carbon milled fibers, metal flakes, metal fibers, metal coated glass fibers, metal coated carbon fibers, metal coated glass flakes, silica, ceramic particles, ceramic fibers, aramid particles, aramid fibers, polyarylate fibers, graphite, a conductive carbon black, various types of whiskers), flame retardants (halogen base, phosphate ester base, metal salt base, red phosphorus, metal hydrate base, etc.), thermal stabilizers, ultraviolet light absorbers, light stabilizers, mold release materials, lubricants, sliding agents (PTFE particle etc.), colorants (pigments and dyes such as carbon black and titanium oxide), light diffusing materials (acrylic crosslinked particles, silicone crosslinked particles, extremely thin glass flakes, calcium carbonate particles, etc.), fluorescent brightener, photoluminescent pigments, fluorescent dyes, antistatic agents, flow modifiers, crystal nucleus materials, inorganic and organic anti-fungus agents, photocatalytic stainproofing agents (fine titanium dioxide, fine zinc oxide, etc.), impact modifiers represented by graft rubber, infrared absorbers, and photochromic materials.

The thermoplastic polycarbonate resin composition of the present invention can be prepared by mixing the above described ingredients (ingredient a), (ingredient b), (ingredient c) and (ingredient d), and besides, various types of additives, if necessary, and kneading the mixture. The mixing and kneading can be performed by a commonly used process such as a process using a ribbon blender, Henschel mixer, Banbury mixer, drum tumbler, single-screw extruder, twin-screw extruder, cokneader or multi-screw extruder. The heating temperature at the time of kneading is usually selected from those in the range of 240 to 330° C. The flame retardant polycarbonate resin composition thus obtained is molded by any one of various known molding processes, for example, injection molding, blow molding, extrusion, compression molding, calendaring or rotational molding to obtain an molded product of the present invention.

The transfer medium carrying member or intermediate transfer member of the present invention can take the form of a film, sheet, belt or drum by molding the above described flame retardant polycarbonate resin composition by a process such as extrusion, injection molding or cast molding. It may take the form of a sheet or an endless belt, the endless belt being formed by bonding-both ends of a molded sheet by heat fusing, ultrasonic fusing or using an adhesive or by winding a molded sheet with multiple layers and heat fusing the same to a desired thickness. The shape should be determined so that it is the most suitable for the image forming apparatus used. Although the film thickness of the transfer medium carrying member or intermediate transfer member of the present invention varies depending on the Young's modulus or volume resistivity of the binder used, it is preferably 30 μm to 2000 μm and particularly preferably 50 μm to 800 μm.

The transfer medium carrying member or intermediate transfer member of the present invention can have a protective layer, a dielectric layer, a resistant layer or a conductive layer on its front or back surface.

The contact electrification member used in the image forming apparatus of the present invention may take the form of a roller, brush (magnetic brush) or blade. The material of the contact electrification member is selected from the group consisting of various types of metals, conductive metal oxides, a conductive carbon and the mixtures thereof. Or a resin or elastomer having the above described conductive powder dispersed therein may also be used.

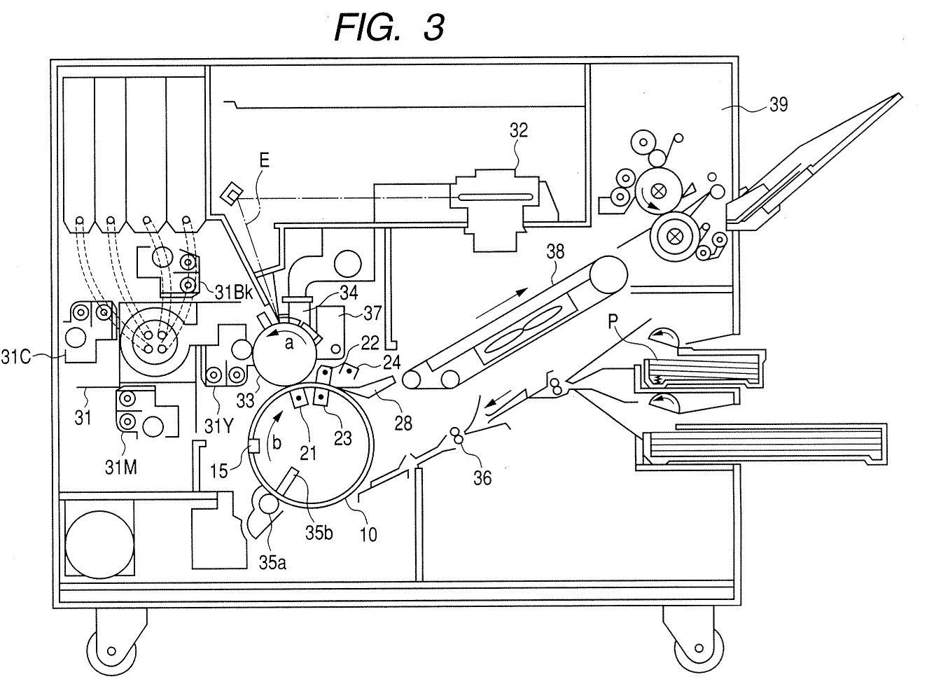

The embodiments of the image forming apparatus that includes a transfer medium carrying member of the present invention are shown in FIGS. 3 to 6. Each image forming apparatus shown in FIGS. 3 to 6 is an example of multi-color (full color) image forming apparatus.

First, a multi-color image forming apparatus will be described briefly with reference to FIG. 3. The multi-color image forming apparatus shown in FIG. 3 includes an image bearing member—that is a photosensitive drum 33, which is freely rotatably supported by a shaft to rotate in the direction shown by the arrow a, and on the periphery portion of the photosensitive drum is arranged image forming means. The image forming means can be arbitrarily selected; however, in this case, the means includes: a primary charger 34 which charges the photosensitive drum 33 uniformly; exposure means 32 made up of, for example, a laser beam exposure device which exposes the charged photosensitive drum 33 to a color-separated light image or a light image corresponding to the color-separated light image to form an electrostatic latent image on the photosensitive drum 33; and a rotary developing device 31 which develops the electrostatic latent image on the photosensitive drum 33 to a visible image.

The rotary developing device 31 is made up of: 4 developing units 31Y, 31M, 31C and 31BK which contain yellow developer, magenta developer, cyan developer and black developer, respectively; and an almost cylindrical case which holds the four developing units and is freely rotatably supported by a shift. The rotary developing device 31 is so constructed that it conveys a desired developing unit to the position opposite to the peripheral surface of the photosensitive drum 33 by the rotation of the case and develops the electrostatic latent image on the photosensitive drum, thereby performing the 4 full color developing process.

The visible image on the photosensitive drum 33—that is the toner image is transferred to a transfer medium P which is conveyed while being carried on a transfer device 10. In this case, the transfer device 10 is a transfer drum which is freely rotatably supported by a shaft.

In the following, the process of forming a full color image on a multi-color electrophotographic copier having the above described construction will be described briefly.

An electrostatic latent image is formed on the photosensitive drum 33 by charging the photosensitive drum 33 uniformly with the primary charger 34 and exposing the charged photosensitive drum to a light image E, which corresponds to the image information, with the exposure means 32. The electrostatic latent image is then made visible on the photosensitive drum 33 as a toner image using a resin-based toner by the rotary developing device 31.

On the other hand, the transfer medium P is fed to the transfer drum 10 in synchronization with the toner image and conveyed in the direction shown by the arrow b in FIG. 3 with its ends gripped by a gripper 15 etc.

Then, the transfer medium P is subjected to corona discharge from a transferring discharger 21 having a polarity opposite to that of the toner, in the region where it comes in contact with the photosensitive drum 33 and from the backside of the inventive transfer medium carrying member 11 attached to the transfer drum 10, to receive the toner image from the photosensitive drum 33.

After the transferring process is repeated required times, the transfer medium P is separated from the transfer drum 10 by the action of a separating claw 28 while subjected to electricity removal by electricity removing dischargers 22, 23 and 24, conveyed to a fuser 39 so that the transferred image is subjected to heat fusing, and discharged outside the apparatus.

The photosensitive drum 33 is cleaned with a cleaning device 37 so that the toner remaining on its surface is removed, and then it is used again for the image forming process.

The surface of the transfer medium carrying member 11 of the transfer drum 10 is also cleaned by the action of a cleaning device 35a that has a blade or fur brush and cleaning auxiliary means 35b, and then it is used again for the image forming process.

In the present invention, preferably an insulating member 26, for example, a polycarbonate resin plate is provided downstream of the transferring corona discharger 21 in the direction in which the transfer drum 10 rotates (in the direction shown by the arrow b), as shown in FIG. 2, so that the amount of the transfer corona in the direction of the photosensitive drum 33 becomes larger.

In the present invention, a pressure member 27 having elasticity may be provided which extends from the transfer medium carrying member 11 introducing side toward the downstream side in the direction in which the transfer medium carrying member moves. The pressure member 27 is made up of a synthetic resin film of, for example, preferably polyethylene, polypropylene, polyester or polyethylene terephthalate whose volume resistivity is preferably 10¹⁰ Ω·cm or more and particularly preferably 10¹⁴ Ω·cm or more and is provided so that it covers the entire transfer portion.

Preferably, the pressure member 27 presses the transfer medium carrying member 11 with its own elastic force and its end portion on the transfer medium carrying member 11 side is arranged in such a position that the transfer medium P finishes to contact with the photosensitive drum 33, starts to contact therewith, or comes closest thereto.

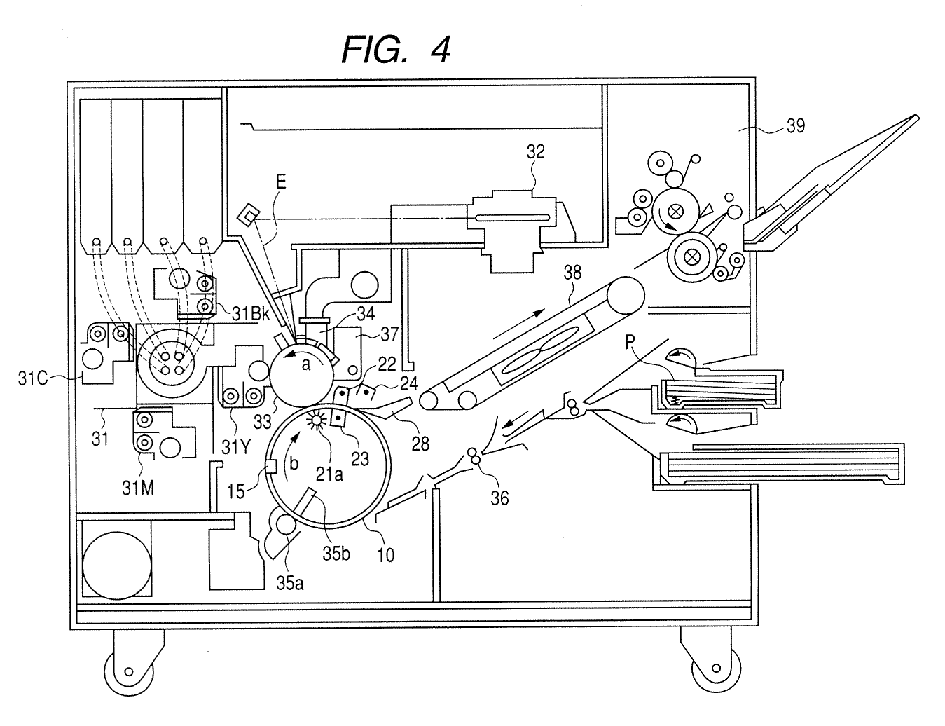

FIG. 4 shows the same multi-color electrophotographic copier as shown in FIG. 3, except that a brush charger 21a is used as a transferring charger 21 which provides charges having an opposite polarity to that of the toner from the backside of the transfer medium carrying member 11. In FIG. 4, the configuration and operation of the other constituents are substantially the same as those in FIG. 3, and therefore, the detailed description of such constituents is omitted.

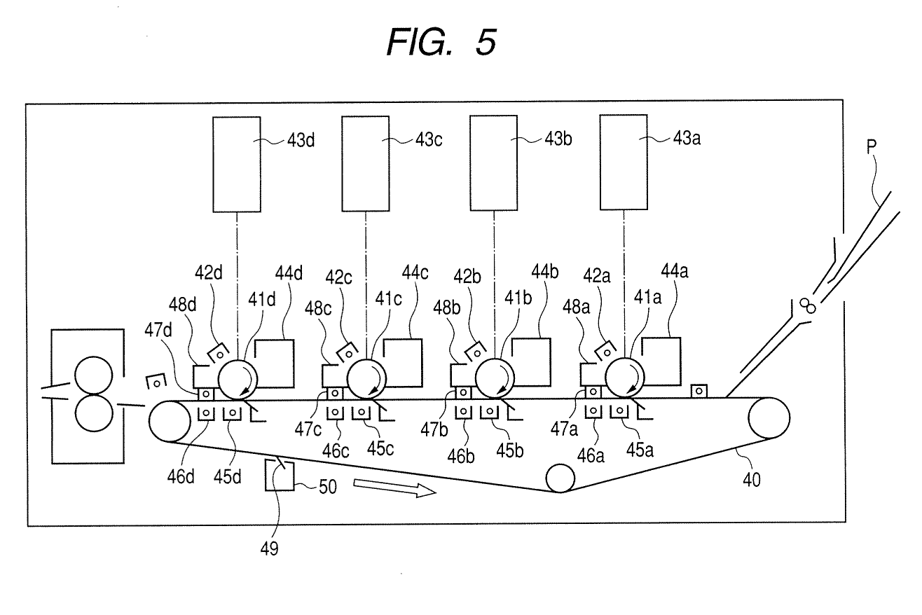

In FIG. 5 shown is a specific example of an image forming apparatus in which a transfer medium carrying member of the present invention which takes the form of an endless belt is used.

The image forming apparatus shown in FIG. 5 includes photosensitive drums 41a to 41d. And primary chargers 42a to 42d, exposure means 43a to 43d, developing equipment 44a to 44d, transferring chargers 45a to 45d, electricity removing dischargers 46a to 46d and 47a to 47d, and cleaning devices for photosensitive drums 48a to 48d are arranged around the respective photosensitive drums, a transfer medium carrying member 40 in the form of an endless belt is arranged under the photosensitive drums in such a manner as to go through the units, and a cleaning device 50 for the transfer medium carrying member which includes a urethane blade 49 is also arranged.

The transfer medium P is fed by a paper feed roller and then conveyed through the transfer portion, in which transferring dischargers 45a to 45d are arranged, by the transfer medium carrying member 40 in the form of an endless belt.

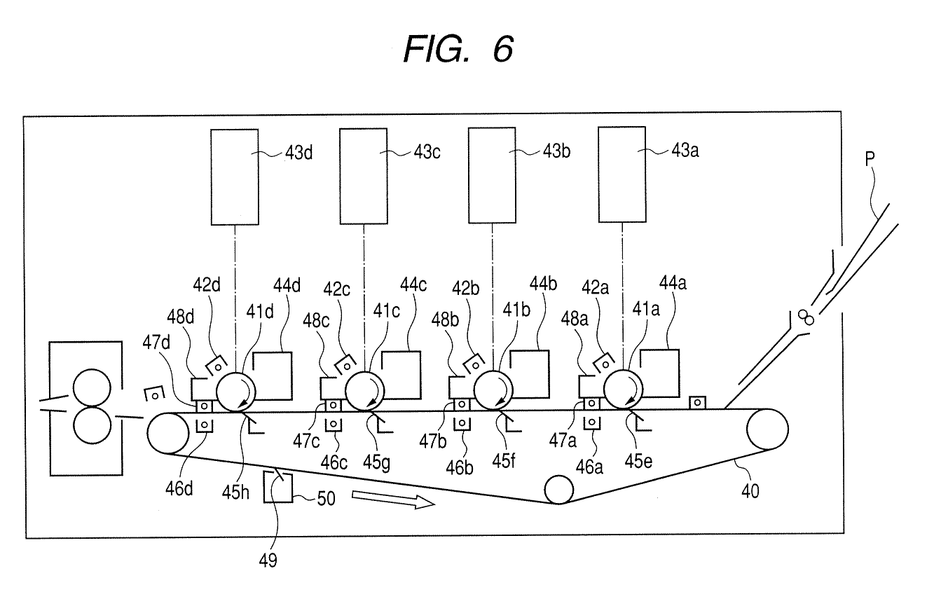

FIG. 6 shows the same image forming apparatus as shown in FIG. 5, except that transferring blade chargers 45e to 45h are used instead of the transfer chargers 45a to 45d. In FIG. 6, the configuration and operation of the other constituents are substantially the same as those in FIG. 5, and therefore, the detailed description of such constituents is omitted.

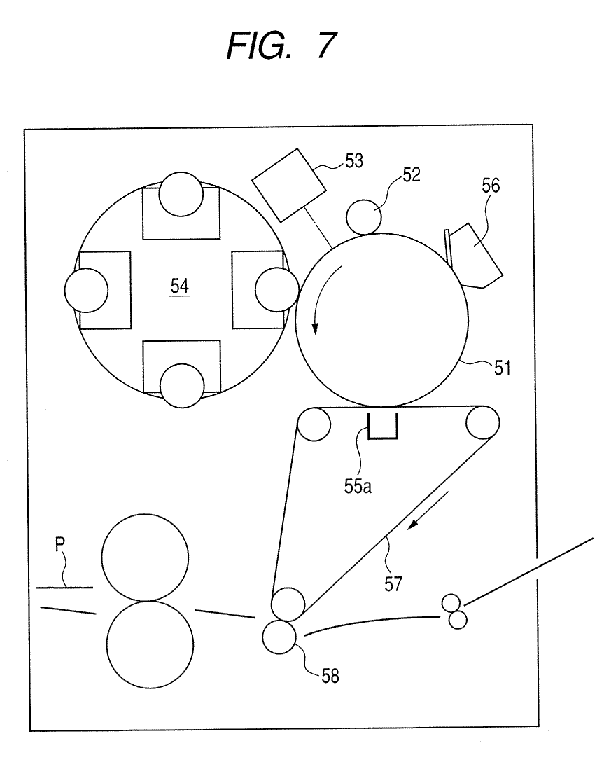

FIG. 7 shows another image forming apparatus in which an intermediate transfer member in the form of an endless belt of the present invention is used. The image forming apparatus includes a photosensitive drum 51. And a primary charging roller 52, exposure means 53, rotary developing equipment 54, a primary transfer corona chargers 55 and a cleaning device for photosensitive drum 56 are arranged around the photosensitive drum. An intermediate transfer 57 in the form of an endless belt of the present invention is arranged under the photosensitive drum, and a second transferring charger 58 is arranged on the intermediate transfer member unit. The transfer medium P is fed by a paper feed roller and then conveyed through the second transfer portion between the intermediate transfer member 57 in the form of an endless belt and the second transfer roller 58.

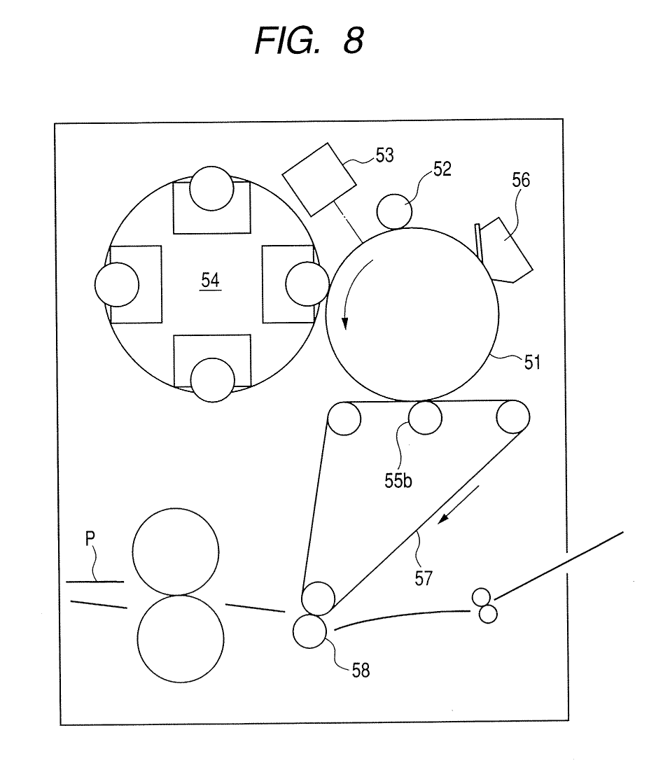

FIG. 8 shows the same image forming apparatus as shown in FIG. 7, except that a primary transfer roller charger 55b is used instead of the primary transfer corona charger 55a. In FIG. 8, the configuration and operation of the other constituents are substantially the same as those in FIG. 7, and therefore, the detailed description of such constituents is omitted.

### EXAMPLES

In the following the present invention will be described in further detail by means of examples; however, it is to be understood that these examples are not intended to limit the present invention.

(Raw Materials)

Synthesis of polycarbonate resins used in the examples of the present invention and comparative examples and the other raw materials used in the same will be described below.

(Ingredient b)

### Synthesis Example 1

### Synthesis of PC(b1)

First, 0.35 kg of polyorganosiloxane compound having the structure shown below (X-22-1821, by Shin-Etsu Chemical Co., Ltd.), 6.65 kg of 2,2-bis(4-hydroxyphenyl)propane (Hereinafter, referred to simply as BPA) and 20 g of hydrosulfite were added to and dissolved in 42 liters of 8.8% (w/v) sodium hydroxide solution in water. Then, 36 liters of methylene chloride was added and 3.50 kg of phosgene was blown in the solution at a ratio of 0.12 kg/min, while keeping the solution at 15° C. and agitating the same. After completing the blow of phosgene, 158 g of p-tert-butylphenol (Hereinafter, referred to simply as PTBP) was added to the solution, followed by vigorous agitation for 10 minutes. Then, 10 ml of triethylamine was added, and the solution was agitated for about 1 hour to allow polymerization to progress. 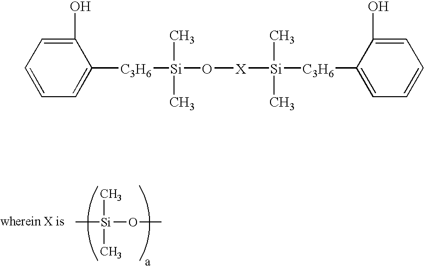
a is on average 39.

The polymer solution was separated into an aqueous phase and an organic phase and the organic phase was neutralized with phosphoric acid. Then, the neutralized organic phase was washed with water repeatedly until the electrical conductivity of the washing became 10 μS/cm or less to obtain a purified resin solution. The obtained purified resin solution was then added dropwise slowly to warm water at 60° C. with the warm water vigorously agitated and the polymerization product was solidified while removing the solvent. The resultant solid matter was filtered and dried to obtain white powdered polymer. In the 0.5 g/dl solution of the polymer in methylene chloride, the intrinsic viscosity [μ] of the polymer at 20° C. was 0.48 dl/g. Hereinafter, the synthesized polycarbonate copolymer is referred to simply as PC(b1). In the analysis of the obtained polymer using infrared absorption spectrum, the siloxane bond absorption spectrum was observed at about 1000 to 1100 cm⁻¹, the carbonyl group absorption spectrum at about 1770 cm⁻¹, and the ether bond absorption spectrum at about 1240 cm⁻¹. This revealed that the obtained polymer had both the siloxane bond and the carbonate bond. The absorption associated with hydroxyl group was hardly observed at 3650 to 3200 cm⁻¹. The GPC analysis of the monomers in the obtained polymer showed that the concentrations of the monomers were all 20 ppm or less. After taking everything into consideration, the present inventors concluded that the obtained polymer was polycarbonate polymer having the same copolymerization ratio as the feed composition.

### Synthesis Example 2

### Synthesis of PC(b2)

Polycarbonate copolymer was synthesized in the same manner as in synthesis example 1, provided that the amount of polyorganosiloxane compound, which had the same structure as that of synthesis example 1, used was 1.14 kg and the amount of BPA used was 6.46 kg. The intrinsic viscosity of the resultant polycarbonate copolymer was 0.45 dl/g. Hereinafter, the synthesized polycarbonate copolymer is referred to simply as PC(b2). The analyses using infrared absorption spectrum etc. revealed that PC(b2) had an equal polycarbonate copolymer structure with that of PC in synthesis example 1 except the copolymerization ratio.

### Synthesis Example 3

### Synthesis of PC(b3)

Polycarbonate copolymer was synthesized in the same manner as in synthesis example 1, provided that 4.45 kg of 2,2-bis(4-hydroxy-3-methylphenyl)propane and 2.64 kg of BPA were used. The intrinsic viscosity of the resultant polycarbonate copolymer was 0.51 dl/g. Hereinafter, the synthesized polycarbonate copolymer is referred to simply as PC(b3). In the analysis of the obtained polymer using infrared absorption spectrum, the carbonyl group absorption spectrum was observed at about 1770 cm⁻¹ and the ether bond absorption spectrum at about 1240 cm⁻¹. This revealed that the obtained polymer had the carbonate bond. The absorption associated with hydroxyl group was hardly observed at 3650 to 3200 cm⁻¹. The GPC analysis of the monomers in the obtained polymer showed that the concentrations of the monomers were all 20 ppm or less. After taking everything into consideration, the present inventors concluded that the obtained polymer was polycarbonate polymer having the same copolymerization ratio as the feed composition.

PC1 obtained from bisphenol A: trade name: IUPILON S-2000, by MITSUBISHI GAS CHEMICAL COMPANY, INC., intrinsic viscosity: 0.53 dl/g. Hereinafter, referred to as BPAPC1.

PC2 obtained from bisphenol A: trade name: IUPILON E-1000, by MITSUBISHI GAS CHEMICAL COMPANY, INC., intrinsic viscosity: 0.61 dl/g. Hereinafter, referred to as BPAPC2.

(Ingredient a)

### Synthesis Example 4

### Synthesis of PC(a1)

First, 2.60 kg of polyorganosiloxane compound having the structure shown below (X-22-1827, by Shin-Etsu Chemical Co., Ltd.), 3.91 kg of 9,9-bis(4-hydroxy-3-methylphenyl)fluorene (Hereinafter, referred to simply as BCFL), 0.49 kg of BPA and 20 g of hydrosulfite were added to and dissolved in 30 liters of an aqueous 8.8% (w/v) sodium hydroxide solution in water. Then, 30 liters of methylene chloride was added and 1.81 kg of phosgene was blown in the solution at a ratio of 0.12 kg/min under agitation, while keeping the solution at 15° C. After completing the blow of phosgene, 88 g of PTBP was added to the solution, followed by vigorous agitation for 10 minutes. Then, 50 ml of triethylamine was added, and the solution was agitated for about 1 hour to allow polymerization to progress. 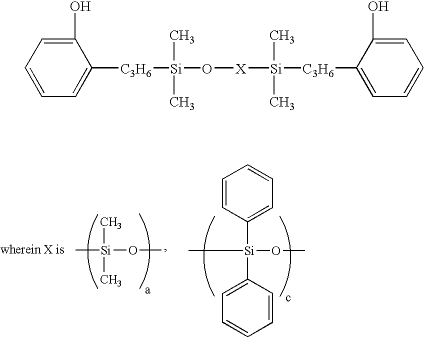
a plurality of these blocks are bound at random. The average of the sums of the dimethyl blocks is 26. The average of the sums of the diphenyl blocks is 13.

After that, the resultant polymer solution was treated in the same manner as in synthesis example 1 to produce polycarbonate copolymer. The intrinsic viscosity of the obtained polycarbonate copolymer was 0.28 dl/g. Hereinafter, the synthesized polycarbonate copolymer is referred to as PC(a1). The analyses using infrared absorption spectrum etc. revealed that this polymer was polycarbonate polymer having the same copolymerization ratio as the feed composition.

### Synthesis Example 5

### Synthesis of PC(a2)

Polycarbonate copolymer was synthesized in the same manner as in synthesis example 4, provided that the polyorganosiloxane compound was replaced by the polyorganosiloxane compound used in synthesis example 1 (X-22-1821, by Shin-Etsu Chemical Co., Ltd.). The intrinsic viscosity of the obtained polycarbonate copolymer was 0.29 dl/g. Hereinafter, the synthesized polycarbonate copolymer is referred to as PC(a2). The analyses using infrared absorption spectrum etc. revealed that this polymer was polycarbonate polymer having the same copolymerization ratio as the feed composition.

### Synthesis Example 6

### Synthesis of PC(Si)

First, 60 kg of bisphenol A was dissolved in 400 liters of 5% by weight sodium hydroxide solution in water. This solution, with its temperature kept at room temperature, and methylene chloride were introduced into a tubular reactor having an inside diameter of 10 mm and a tube length of 10 m through an orifice plate at flow rates of 138 liters/hour and 69 liters/hour, respectively. And phosgene was blown into the reactor at a flow rate of 10.7 kg/hour so that it flowed parallel with the above mixed solution and reacted with bisphenol A continuously for 3 hours. The tubular reactor used had a duplex tube structure, and cooling water is passed through its jacket portion to keep the temperature of the reaction solution discharged from the reactor at 25° C. The pH of the discharged solution was adjusted to 10 to 11. The reaction solution thus obtained was allowed to stand to separate and remove the water phase. Thus, 220 liters of methylene chloride phase was collected and the intended polycarbonate oligomer solution was obtained. The concentration of the oligomer was 317 g/l, while that of chloroformate was 0.7 N.

Then, 40 g of a siloxane compound having the structure shown below was dissolved in 2 liters of methylene chloride, and this solution, in which the siloxane compound was dissolved, was mixed with 10 liters of the polycarbonate oligomer solution prepared as above. A solution prepared by dissolving 56 g of sodium hydroxide in 1 liter of water and 5.7 cc of triethylamine were added to the above mixed solution, and the mixed solution was agitated at 300 rpm at room temperature for 1 hour. After that, a solution prepared by dissolving 600 g of bisphenol A in 5 liter of 5.2 wt % solution of sodium hydroxide in water, 8 liters of methylene chloride and 96 g of p-t-butylphenol were added to the mixed solution, and the mixture was agitated at 500 rpm at room temperature for 2 hours. Then, 5 liters of methylene chloride was added, the mixed solution was subjected to washing with 5 liters of water, alkali washing with 5 liters of 0.01 N solution of sodium hydroxide in water, acid washing with 5 liters of 0.1N hydrochloric acid and water washing with 5 liters of water in this order, and lastly methylene chloride was removed from the washed solution to obtain a flaky polycarbonate copolymer. The resultant polycarbonate copolymer had a viscosity average F molecular weight of 17,000 and a siloxane compound unit content of 1 wt %. Hereinafter, the polycarbonate copolymer is referred to simply as PC(Si). 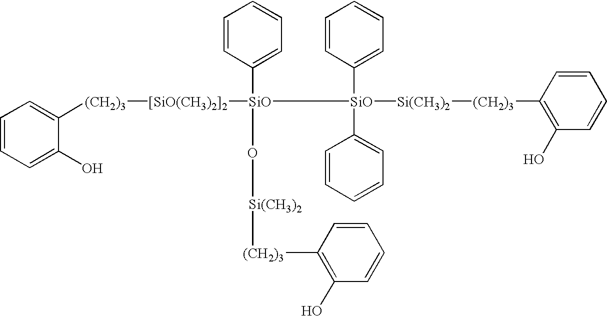
The intrinsic viscosity of the copolymer was 0.40 dl/g.

Silicone resin: A silicone resin of a branched structure having methyl and phenyl groups as substituents (X-40-9805, by Shin-Etsu Chemical Co., Ltd.) was used. Hereinafter, this silicone resin is referred to simply as Si-1.

(Ingredient c)

As ingredient c, the following materials were prepared.

CNT: Carbon nanotube having an average fiber diameter of 10 nm and average fiber length of 1 μm or more, by Hyperion Catalysis International, Inc. 15% by weight of this carbon nanotube and PC(b1) synthesized in the above described synthesis example 1 were melted and kneaded at 270 to 290° C. with a cokneader by Buss and then cooled to obtain master batch pellets in which carbon fibers were dispersed. The pellets were used in examples.

CB: Carbon black (trade name: Ketjenblack EC, by Lion Corporation (DBP oil absorption: 360 ml/100 g)) was used.

(Ingredient d)

As ingredient d, the following metal salts were used.

Metal salt 1: potassium perfluorobutanesulfonate salt (trade name: Megafac F-114P, by Dainippon Ink and Chemicals, Inc.)

Metal salt 2: potassium diphenylsulfonate salt (KSS, by UCB)

### Examples 1 to 13

The above described raw materials, ingredients a, b, c and d, were weighed in the ratios shown in Table 1-1 and Table 1-2. The ingredients a, b and d weighed in each ratio were pre-mixed with a super mixer, the ingredient c was added to the mixture, and the mixture was melted and kneaded at 270 to 290° C. with a 40-mm extruder with a vent and cooled to obtain pellets. The pellets were dried in a hot-air drier at 120° C. for 6 hours and molded into a film 100 μm thick with a compression molding press at 300° C. to obtain a test film. Volume resistivity and surface resistivity were measured for each of the obtained test films with a high-resistivity meter, Hiresta-UP (Mitsubishi Chemical Corporation), at a measuring voltage of 100V and a measuring time of 10 seconds. Flame retardancy VTM test was conducted in accordance with UL-94VTM to evaluate the flame retardancy of each film test piece 100 μm thick (50 mm wide and 200 mm long).

Folding endurance was measured by MIT folding endurance test (tension 1.00 kg/mm²) and evaluated based on the following criteria for each film test piece 100 μm thick (10 mm wide and 50 mm long). The results are shown in Table 1-1 and Table 1-2.
A: Resin film was not broken by 50,000 times of folding.
B: Resin film was broken by 30,000 times or more and less than 50,000 times of folding.
C: Resin film was broken by less than 30,000 times of folding.

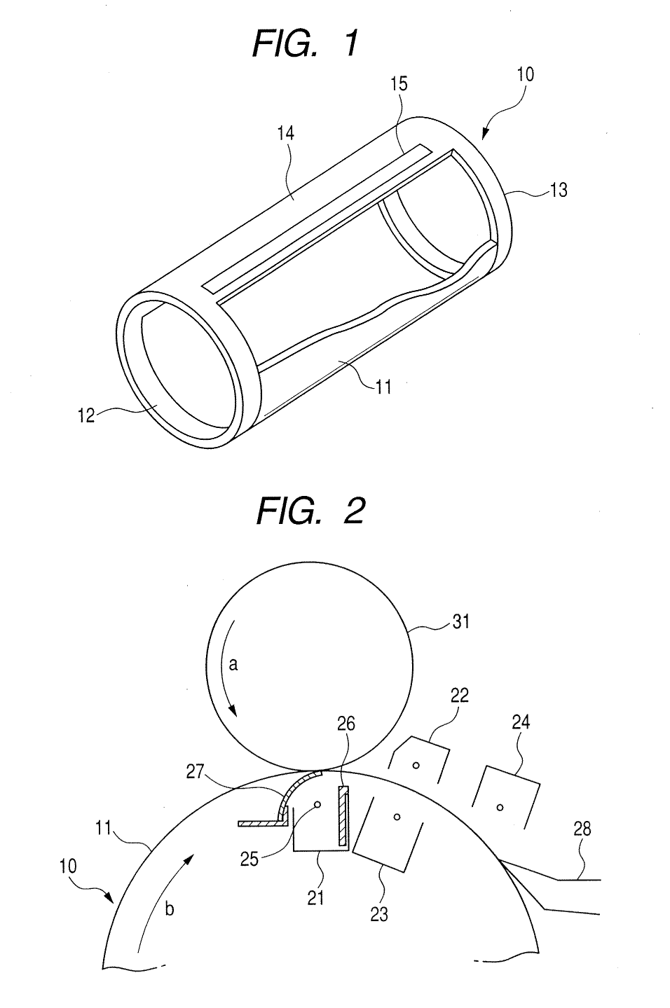

Each of the resin films formed above was used to make a transfer drum as shown in FIG. 1. Specifically, each of the resin films, as the transfer medium carrying member 11 shown in FIG. 1, was stretched between the aluminum cylinders 12 and 13 to form the transfer drum 10. Both ends of the transfer medium carrying member 11 were fixed on the connecting portion 14 for connecting the two aluminum cylinders 12 and 13 that constituted the transfer drum 10.

In these examples, the diameter of the transfer drum 10 was set to 160 mm and the moving speed of the same to 160 mm/sec. The process speed, which was the moving speed of a photosensitive drum 33 etc., was also set to 160 mm/sec. The opening width of the transferring corona discharger 21 was set to 19 mm, the distance between the discharge wire 25 and the peripheral surface of the photosensitive drum 33 to 10.5 mm, and the distance between the discharge wire 25 and the shield plate bottom surface of the transferring corona discharger 22 to 16 mm.

As the pressing member 27, used was a polyethylene terephthalate resin film.

In these examples, a latent image was formed on the photosensitive drum 33 charged negatively with an image forming apparatus as shown in FIG. 3 and a toner image was obtained by reversal development using toner 8 μm in average particle size. The toner, in this case, was made up of; a resin; coloring materials; and very small amounts of other additives for improving the charge controlling properties or lubricating properties, and it was discharged negatively in a developing device by the triboelectric charging with carrier particles.

After that, the toner image was transferred to a transfer medium with a transfer apparatus constructed as above by means of positive polarity. Then the transfer medium was separated from the transfer drum 10 and the image was fixed with a fixing device.

In these examples, the surface of the transfer medium carrying member 11 of the transfer drum 10 was cleaned with a cleaning device 35a having a urethane blade and an auxiliary cleaning means 35b.

20,000-copy printing out endurance test was conducted using a multi-color electrophotographic copying machine shown in FIG. 3. Both of the initial image and the image after the endurance were visually observed and evaluated based on the following criteria. The results are shown in Table 1-1 and Table 1-2.

A: No non-uniformity was observed.

B: Non-uniformity was observed.

### Comparative Examples 1 to 2

The above described raw materials, ingredients a, b, c and d, were weighed in the ratios shown in Table 2, and resin films were formed in the same manner as in the above described examples 1 to 13. The volume resistivity and the surface resistivity were measured for each of the resultant resin films, and flame retardancy VTM test and MIT folding endurance test were conducted for each film. Further, a transfer drum was made in the same manner as in the above described examples using each of the resin films formed in these comparative examples. Image properties were evaluated for each resin films. The results are shown in Table 2.

TABLE 1-1

| | | | Example | Example | Example | Example | Example | Example | Example |
|---|---|---|---|---|---|---|---|---|---|
| | | | 1 | 2 | 3 | 4 | 5 | 6 | 7 |
| Mixing ratio | Ingredient b | PC(b1) | 74 | | | 84 | 5 | 74 | 74 |
| (Part by weight) | | PC(b2) | | 24 | | | | | |
| | | PC(b3) | | | 74 | | | | |
| | | BPAPC1 | | 50 | | | | | |
| | Ingredient a | PC(a1) | 20 | 20 | 20 | 10 | 89 | | 20 |
| | | PC(a2) | | | | | | 20 | |
| | Ingredient c | CB | 6 | 6 | 6 | 6 | 6 | 6 | 6 |
| | | CNT | | | | | | | |
| | Total | | 100 | 100 | 100 | 100 | 100 | 100 | 100 |
| | Ingredient d | Metal salt 1 | 0.2 | 0.2 | 0.2 | 0.2 | 0.2 | 0.2 | 0.05 |
| | | Metal salt 2 | | | | | | | |
| Evaluations | Volume resistivity (Ω · cm) | | 4.8 × 10¹⁰ | 6.3 × 10¹⁰ | 6.0 × 10¹⁰ | 3.6 × 10¹⁰ | 2.5 × 10¹⁰ | 4.7 × 10¹⁰ | 5.6 × 10¹⁰ |
| | Surface resistivity (Ω/∇) | | 1.7 × 10¹¹ | 3.8 × 10¹¹ | 7.2 × 10¹¹ | 2.9 × 10¹¹ | 5.5 × 10¹¹ | 2.2 × 10¹¹ | 6.5 × 10¹¹ |
| | Flame retardancy VTM test | | VTM-1 | VTM-1 | VTM-1 | VTM-1 | VTM-2 | VTM-1 | VTM-1 |
| | MIT folding endurance test | | A | A | A | A | A | A | A |
| | Image properties | Initial | A | A | A | A | A | A | A |
| | | After endurance | A | A | A | A | A | A | A |

TABLE 1-2

| | | | Example | Example | Example | Example | Example | Example |
|---|---|---|---|---|---|---|---|---|
| | | | 8 | 9 | 10 | 11 | 12 | 13 |
| Mixing ratio | Ingredient b | PC(b1) | 74 | 74 | 78 | 76 | 74 | |
| (Parts by weight) | | PC(b2) | | | | | | |
| | | PC(b3) | | | | | | |
| | | BPAPC1 | | | | | | 74 |
| | Ingredient a | PC(a1) | 20 | 20 | 20 | 20 | 20 | 20 |
| | | PC(a2) | | | | | | |
| | Ingredient c | CB | 6 | 6 | | 3 | 6 | 6 |
| | | CNT | | | 2 | 1 | | |
| | Total | | 100 | 100 | 100 | 100 | 100 | 100 |
| | Ingredient d | Metal salt 1 | 0.005 | 0.5 | 0.2 | 0.2 | | 0.2 |
| | | Metal salt 2 | | | | | 0.2 | |
| Evaluations | Volume resistivity (Ω · cm) | | 5.6 × 10¹⁰ | 4.2 × 10¹⁰ | 4.7 × 10¹⁰ | 6.7 × 10¹⁰ | 3.1 × 10¹⁰ | 4.8 × 10¹⁰ |
| | Surface resistivity (Ω/∇) | | 6.5 × 10¹¹ | 5.2 × 10¹¹ | 3.5 × 10¹¹ | 4.5 × 10¹¹ | 8.1 × 10¹¹ | 4.2 × 10¹¹ |
| | Flame retardancy VTM test | | VTM-2 | VTM-1 | VTM-1 | VTM-1 | VTM-1 | VTM-1 |
| | MIT folding endurance test | | A | A | A | A | A | B |
| | Image properties | Initial | A | A | A | A | A | A |
| | | After endurance | A | A | A | A | A | A |

TABLE 2

| | | | Comparative | Comparative |
|---|---|---|---|---|
| | | | example 1 | example 2 |
| Mixing ratio | Ingredient b | PC(b1) | | |
| (Part by weight) | | PC(b2) | | |
| | | PC(b3) | | |
| | | BPAPC1 | 75 | |
| | | BPAPC2 | | 94 |
| | Ingredient a | PC(a1) | | |
| | | PC(a2) | | |
| | Si ingredient | PC(Si) | 19 | |
| | other than | | | |
| | ingredient a | | | |
| | Ingredient c | CB | 6 | 6 |
| | | CNT | | |
| | Total | | 100 | 100 |
| | Ingredient d | Metal salt 1 | 0.2 | 0.2 |
| | | Metal salt 2 | | |
| Evaluations | Volume resistivity (Ω · cm) | | 4.7 × 10¹⁰ | 4.6 × 10¹⁰ |
| | Surface resistivity (Ω/∇) | | 4.9 × 10¹¹ | 5.6 × 10¹¹ |
| | Flame retardancy VTM test | | not VTM | not VTM |
| | MIT folding endurance test | | B | B |
| | Image properties | Initial | A | A |
| | | After endurance | B | A |

### Examples 14 to 15

The films obtained in examples 1 and 2 were formed into endless belt-like films by ultrasonic welding, and the images were obtained with an image forming apparatus shown in FIG. 5 using the endless belt-like films and the same toner as that of example 1. The image properties were evaluated for each of the endless belt-like films.

Further, 20,000-copy printing out endurance test was conducted using the above described multi-color electrophotographic copying machine. As a result, no non-uniformity was observed in both the initial images and the images after endurance.

### Examples 16 to 17

The films obtained in examples 1 and 2 were formed into endless belt-like films by ultrasonic welding, and the images were obtained with an image forming apparatus shown in FIG. 7 using the endless belt-like films and the same toner as-that of example 1. The image properties were evaluated for each of the endless belt-like films.

Further, 20,000-copy printing out endurance test was conducted using the above described multi-color electrophotographic copying machine. As a result, no non-uniformity was observed in both the initial images and the images after endurance.

As described so far, according to the present invention, can be provided a transfer medium carrying member or intermediate transfer member that excel in flame retardancy, have high film strength and are less likely to electrically deteriorate, and therefore provide good images, which are free from transfer non-uniformity or defect of transferred colorant even after repeatedly used, and an image forming apparatus using the same. Thus, the transfer medium carrying member or intermediate transfer member and the image forming apparatus of the present invention can be very suitably used in the filed of electrophotography.

This application claims priority from Japanese Patent Application Nos. 2004-170143 filed on Jun. 8, 2004 and 2005-055805 filed on Mar. 1, 2005, which are hereby incorporated by reference herein.

What is claimed is:

1. An intermediate transfer member used in electrophotographic apparatus, comprising i) a resin and ii) a conductive filler, wherein said resin comprises a polycarbonate resin (a) having a structural unit including a siloxane structure and a structural unit including a fluorene structure.

2. The intermediate transfer member according to claim 1, wherein the polycarbonate resin (a) has a structural unit represented by the following general formula (1) and a structural unit represented by the following general formula (3): 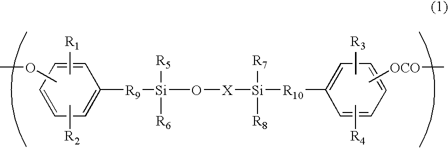
wherein R₁ to R₄ each independently represent a hydrogen, an alkyl group having 1 to 5 carbon atoms, an aryl group having 6 to 12 carbon atoms, an alkenyl group having 2 to 5 carbon atoms, an alkoxy group having 1 to 5 carbon atoms or an aralkyl group having 7 to 17 carbon atoms; R₅ to R₈ each independently represent a hydrogen, an alkyl group having 1 to 5 carbon atoms, an aryl group having 6 to 12 carbon atoms, an alkenyl group having 2 to 5 carbon atoms, an alkoxy group having 1 to 5 carbon atoms or an aralkyl group having 7 to 17 carbon atoms; R₉ and R₁₀ each independently represent a single bond or a divalent aliphatic hydrocarbon group having 1 to 6 carbon atoms; and
X is a single bond, a linking group composed of any one structural unit selected from the group consisting of structural units represented by [—SiO(R₁₁)(R₁₂)—], [—SiO(R₁₃)(R₁₄)—] or [—SiO(R₂₉)(R₃₀)—], or a linking group composed of a polymer of at least one structural unit selected from the group consisting of said three structural units,
wherein, when said linking group is composed of a polymer of at least one structural unit selected from the group consisting of said three structural units, the sum of the polymerization degree is 2 to 200,
when said linking group is composed of a polymer of at least two structural units selected from the group consisting of said three structural units, the polymer is a block or random copolymer of the structural units, and
in said structural units, R₁₁ to R₁₄ and R₂₉ to R₃₀ each independently represent a hydrogen, an alkyl group having 1 to 5 carbon atoms, an aryl group having 6 to 12 carbon atoms, an alkenyl group having 2 to 5 carbon atoms, an alkoxy group having 1 to 5 carbon atoms or an aralkyl group having 7 to 17 carbon atoms, the combinations of R₁₁ and R₁₂, R₁₃ and R₁₄, and R₂₉ and R₃₀ are different from one another; and 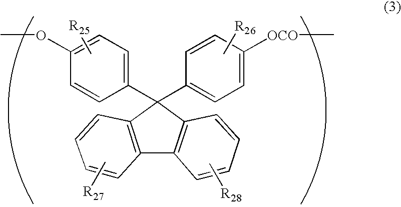
wherein R₂₅ to R₂₈ each independently represent a hydrogen, an alkyl group having 1 to 5 carbon atoms, an aryl group having 6 to 12 carbon atoms, an alkenyl group having 2 to 5 carbon atoms, an alkoxy group having 1 to 5 carbon atoms or an aralkyl group having 7 to 17 carbon atoms.

3. The intermediate transfer member according to claim 2, wherein in the formula (1), R₅ to R₈ each independently represent a methyl or phenyl group.

4. The intermediate transfer member according to claim 3, wherein the structural unit represented by the formula (1) has at least one structure selected from the group consisting of the structures represented by the following formulae (4) and (5): 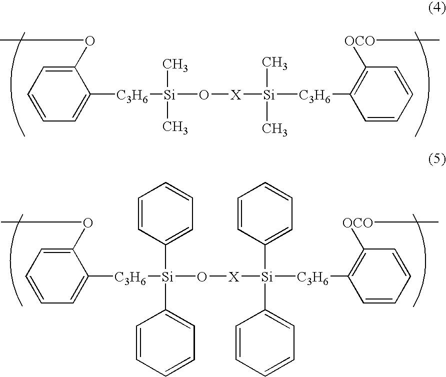
X is defined as in the above formula (1).

5. The intermediate transfer member according to claim 1, wherein said resin further comprises a polycarbonate resin (b), which is different from the polycarbonate resin (a).

6. The intermediate transfer member according to claim 5, wherein said polycarbonate resin (b) has a structural unit represented by the general formula (1) and a structural unit represented by the following general formula (2): 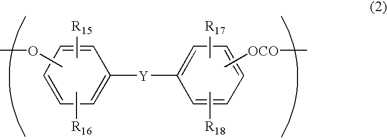
wherein R₁₅ to R₁₈ each independently represent a hydrogen, an alkyl group having 1 to 10 carbon atoms, an aryl group having 6 to 12 carbon atoms, an alkenyl group having 2 to 5 carbon atoms, an alkoxy group having 1 to 5 carbon atoms or an aralkyl group having 7 to 17 carbon atoms; and
Y represents 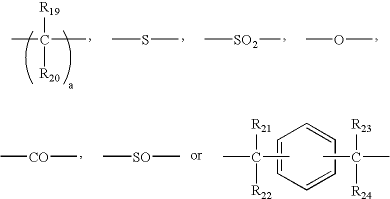
wherein R₁₉ to R₂₀ each independently represent a hydrogen, an alkyl group having 1 to 10 carbon atoms, an alkenyl group having 2 to 5 carbon atoms, an alkoxy group having 1 to 5 carbon atoms or an aryl group having 6 to 12 carbon atoms, or and R₂₁ to R₂₄ each independently represent a hydrogen, an alkyl group having 1 to 10 carbon atoms, an alkenyl group having 2 to 5 carbon atoms, an alkoxy group having 1 to 5 carbon atoms or an aryl group having 6 to 12 carbon atoms, or an atomic group forming a carbon ring having 3 to 12 carbon atoms or heterocyclic ring (excluding a fluorine structure) together with R₂₁ and R₂₂, or R₂₃ and R₂₄; and a is an integer of 0 to 20.

7. The intermediate transfer member according to claim 6, wherein in the formula (1), R₅ to R₈ each independently represent a methyl or phenyl group.

8. The intermediate transfer member according to claim 7, wherein the structural unit represented by the formula (1) has at least one structure selected from the group consisting of the structures represented by the following formulae (4) and (5): 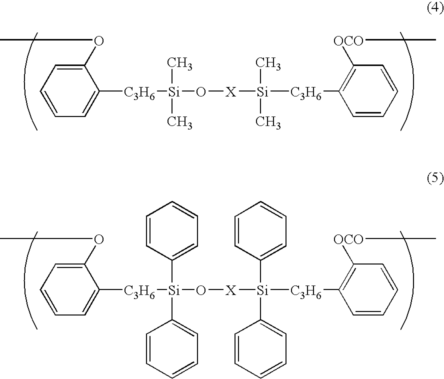
wherein X is defined as in the above formula (1).

9. The intermediate transfer member according to claim 6, wherein the structural unit represented by the formula (2) has the structure represented by the following formula (6).

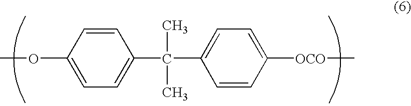

10. The intermediate transfer member according to claim 1, wherein it takes the form of an endless belt.

11. An electrophotographic apparatus, comprising the intermediate transfer member according to claim 1, to which a toner image formed on an image bearing member is transferred and which then transfers the transferred toner image to a transfer medium.
